(19) United States
(12) Patent Application Publication
(10) Pub. No.: US 2026/0063945 A1
(43) Pub. Date: Mar. 5, 2026

(54) POLARIZING PLATE FOR OPTICAL LAMINATE, OPTICAL LAMINATE INCLUDING THE SAME, SMART WINDOW, AND AUTOMOBILE OR WINDOW FOR BUILDING USING THE SAME

(71) Applicant: DONGWOO FINE-CHEM CO., LTD., Iksan-si (KR)

(72) Inventors: Hong-Jun AHN, Iksan-si (KR); Dong-Hwi KIM, Iksan-si (KR)

(73) Assignee: DONGWOO FINE-CHEM CO., LTD., Iksan-si (KR)

(21) Appl. No.: 19/309,960

(22) Filed: Aug. 26, 2025

(30) Foreign Application Priority Data
Sep. 2, 2024 (KR) 10-2024-0118356
Mar. 20, 2025 (KR) 10-2025-0035711

(51) Int. Cl. G02F 1/1335

(52) U.S. Cl. CPC G02F 1/133528

(57) ABSTRACT

The present disclosure provides a polarizing plate for an optical laminate, including a polarizer and a protective film formed on one surface of the polarizer, wherein the protective film has a thickness of 100 μm to 300 μm. Also provided is an optical laminate including the polarizing plate. Accordingly, the present disclosure relates to a smart window in which defects due to the level difference between a liquid crystal layer and a sealant are prevented and which has excellent visibility, and an automobile or a window for a building using the same.

### CROSS-REFERENCE TO RELATED APPLICATION(S)

This application claims the benefit under 35 USC 119 (a) of Korean Patent Application No. KR 10-2024-0118356, filed on Sep. 2, 2024 and Korean Patent Application No. KR 10-2025-0035711, filed on Mar. 20, 2025, with the Korean Intellectual Property Office, the disclosure of which is incorporated herein by reference in its entirety.

### BACKGROUND

### 1. Technical Field

The present disclosure relates to a polarizing plate for an optical laminate, an optical laminate including the same, a smart window, and an automobile or a window for a building using the same.

### 2. Related Art

In general, there are many cases in which an external light blocking coating is applied to a glass window of a means of transportation such as a vehicle. However, the transmittance of a conventional glass window of a means of transportation is fixed, and the transmittance of the external light blocking coating is also fixed.

Therefore, the overall transmittance of the conventional window of the means of transportation is fixed, which may cause an accident. For example, when the overall transmittance is preset low, there is no problem during day when ambient light is sufficient. However, there is a problem in that it is difficult for a driver or the like to properly check the surroundings of the means of transportation at night when ambient light is insufficient. Alternatively, when the overall transmittance is preset high, there is a problem of causing glare to a driver or the like during day when ambient light is sufficient. Accordingly, an optical laminate capable of changing the transmittance of light when a voltage is applied has been developed.

The optical laminate is driven to change transmittance by driving liquid crystals in response to application of a voltage. The optical laminate achieves a desired transmittance by including a liquid crystal layer whose phase changes in response to the application of an electric field for varying the transmittance. The optical laminate is applied to a smart window and used in places where a change in the transmittance of light is required, such as means of transportation or windows for buildings.

In general, in order to prevent the liquid crystal layer from detaching, a sealant is applied to the outer peripheral surface of the liquid crystal layer in the optical laminate. However, as shown in FIG. 4, there is a problem in that, due to the difference in properties between a liquid crystal layer 20 and a sealant 30, a level difference (d) is generated on the outer surface of a first laminate 10-1, positioned on the liquid crystal layer 20 and sealant 30 formed on a second laminate 10-2. Thus, there is a problem in that surface waviness and bubbles are generated, especially in a glass bonding process for applying the optical laminate to a smart window, and are visible as spots on the exterior of the smart window. In addition, a smart window having applied thereto a protective film with high moisture permeability has a problem in that, when exposed to high-temperature and high-humidity environments for long periods of time, bubbles enter the liquid crystal layer, causing deformation. This causes problems for the smart window because the bubbles entering the liquid crystal layer are visible as amorphous black spot defects.

Korean Patent No. 10-2154513 discloses a smart window with improved transparency and visibility, but does not recognize the aforementioned problems and does not suggest any alternative solutions to the aforementioned problems.

Accordingly, there is a need to develop an optical laminate in which no spots are visible by preventing the problem caused by the level difference between the liquid crystal layer and the sealant and no defects occur as a result of improving heat and moisture resistance.

### SUMMARY

The present disclosure is intended to provide a polarizing plate, which prevents defects from occurring due to the level difference between a liquid crystal layer and a sealant, thereby preventing concerns about reduced visibility due to spots, and an optical laminate including the same.

The present disclosure is also intended to provide a polarizing plate, which may be prevented from being deformed due to long-term voltage application, and an optical laminate including the same.

The present disclosure is also intended to provide a smart window including the polarizing plate and the optical laminate, and an automobile or a window for a building using the same.

However, the problems to be solved by the present disclosure are not limited to the problems mentioned above, and other problems not mentioned will be clearly understood by those skilled in the art from the following description.

The present disclosure relates to a polarizing plate for an optical laminate including a polarizer and a protective film formed on one surface of the polarizer, wherein the protective film has a thickness of 100 μm to 300 μm.

The polarizing plate may have a thickness of 150 μm to 500 μm.

The protective film may have an in-plane retardation of less than 4,000 nm for light having a wavelength of 550 nm.

The protective film may have a multilayer structure in which a plurality of layers are sequentially laminated.

The polarizing plate may further include a retardation matching layer on the surface on which the protective film is not formed.

The polarizing plate may include, on the retardation matching layer, at least one functional layer selected from the group consisting of a hard coating layer and a refractive index-matching layer.

The present disclosure relates to an optical laminate including: a first polarizing plate; a first transparent conductive layer formed on one surface of the first polarizing plate; a second polarizing plate opposite to the first polarizing plate; a second transparent conductive layer formed on one surface of the second polarizing plate and opposite to the first transparent conductive layer; a liquid crystal layer provided between the first transparent conductive layer and the second transparent conductive layer; and a sealant formed along the outer peripheral surface of the liquid crystal layer, wherein at least one of the first transparent conductive layer and the second transparent conductive layer is formed in direct contact with any one of the first polarizing plate and the second polarizing plate, and the first polarizing plate and the second polarizing plate include a first protective film and a second protective film, respectively, on surfaces on which the first transparent conductive layer and the second transparent conductive layer are not formed, wherein the first protective film and the second protective film each have a thickness of 100 μm to 300 μm.

The first polarizing plate and the second polarizing plate may each have a thickness of 150 μm to 500 μm.

The first protective film and the second protective film may have an in-plane retardation of less than 4,000 nm for light having a wavelength of 550 nm.

The first protective film and the second protective film may have a multilayer structure in which a plurality of layers are sequentially laminated.

At least one of the first polarizing plate and the second polarizing plate may further include a first retardation matching layer or a second retardation matching layer on a surface on which the first protective film or the second protective film is not formed.

At least one of the first polarizing plate and the second polarizing plate may include, on the retardation matching layer, at least one functional layer selected from the group consisting of a hard coating layer and a refractive index-matching layer.

At least one of the first transparent conductive layer and the second transparent conductive layer may be formed in direct contact with any one of the first polarizing plate and the second polarizing plate without including a separate substrate therebetween. At least one of the first transparent conductive layer and the second transparent

conductive layer may be formed in direct contact with any one of the first polarizing plate and the second polarizing plate while including a highly adhesive layer therebetween.

At least one of the first transparent conductive layer and the second transparent conductive layer may include at least one selected from the group consisting of a transparent conductive oxide, a metal, a carbonaceous material, a conductive polymer, a conductive ink, and nanowires.

The optical laminate may further include at least one selected from the group consisting of an alignment film, a pressure sensitive adhesive/adhesive layer, and a UV-absorbing layer.

The present disclosure also relates to a smart window including the optical laminate.

The present disclosure also relates to an automobile in which the smart window is applied to at least one of a front window, a rear window, a side window, a sunroof window, and an interior partition.

The present disclosure also relates to a window for a building, including the smart window.

In the polarizing plate and the optical laminate including the same according to the present disclosure, defects due to the level difference between the liquid crystal layer and the sealant do not occur, and thus a spot pattern does not occur, indicating that visibility is excellent.

In addition, the polarizing plate of the present disclosure and the optical laminate including the same have excellent heat and moisture resistance and moisture permeability, and thus may be prevented from deformation.

In addition, the polarizing plate of the present disclosure and the optical laminate including the same have a conductive layer formed directly on one surface of the polarizing plate, and thus do not include a separate substrate for forming the conductive layer, thereby facilitating the process.

In addition, the present disclosure may provide a smart window including the polarizing plate and the optical laminate, and an automobile and a window for a building using the same.

### BRIEF DESCRIPTION OF THE DRAWINGS

FIG. 1 shows a laminated structure of a polarizing plate according to one embodiment of the present disclosure.

FIG. 2 shows a laminated structure of a polarizing plate according to another embodiment of the present disclosure.

FIG. 3 shows the structure of an optical laminate according to one embodiment of the present disclosure.

FIG. 4 schematically shows a state in which a level difference has occurred in a conventional optical laminate.

### DETAILED DESCRIPTION

The present disclosure relates to a polarizing plate that may constitute the outermost part of an optical laminate, and specifically, to a polarizing plate for an optical laminate that may suppress the occurrence of a level difference caused by a sealant when applied to an optical laminate. Specifically, the polarizing plate of the present disclosure is a polarizing plate for an optical laminate including a polarizer and a protective film formed on one surface of the polarizer, wherein the protective film has a thickness of 100 μm to 300 μm.

Moreover, the present disclosure relates to an optical laminate including the polarizing plate, wherein the optical laminate includes: a first polarizing plate; a second polarizing plate; a first transparent conductive layer formed on one surface of the first polarizing plate; a second transparent conductive layer formed on one surface of the second polarizing plate; and a liquid crystal layer and sealant provided between the two transparent conductive layers, and wherein the first polarizing plate and the second polarizing plate may include a first protective film and a second protective film, respectively, formed as thick films on surfaces on which the transparent conductive layer is not formed.

More specifically, the optical laminate of the present disclosure includes: a first polarizing plate; a first transparent conductive layer formed on one surface of the first polarizing plate; a second polarizing plate opposite to the first polarizing plate; a second transparent conductive layer formed on one surface of the second polarizing plate and opposite to the first transparent conductive layer; a liquid crystal layer provided between the first transparent conductive layer and the second transparent conductive layer; and a sealant formed along the outer peripheral surface of the liquid crystal layer, wherein at least one of the first transparent conductive layer and the second transparent conductive layer is formed in direct contact with any one of the first polarizing plate and the second polarizing plate, and the first polarizing plate and the second polarizing plate include a first protective film and a second protective film, respectively, on surfaces on which the first transparent conductive layer and the second transparent conductive layer are not formed, wherein the first protective film and the second protective film each have a thickness of 100 μm to 300 μm.

The optical laminate of the present disclosure is particularly suitable for technical fields where the transmittance of light can be changed in response to the application of voltage, and may be used, for example, for a smart window or the like.

The term “smart window” means an optical structure that controls the amount of light or heat passing therethrough by changing light transmittance in response to the application of an electrical signal. In other words, the smart window is configured to be changed into a transparent, opaque or translucent state by voltage and is also called variable transmittance glass, light control glass, or smart glass.

The smart window may be used as a partition for partitioning the internal space of a vehicle or a building or as a partition for protecting privacy, or may be used as a skylight window arranged at an opening of a building. Furthermore, the smart window may be used as highway signs, notice boards, score boards, clocks or advertisement screens, and may be used to replace windows of vehicles, buses, airplanes, ships, or trains, or glass of means of transportation, such as a sunroof.

The optical laminate of the present disclosure may also be used for the smart window in the various technical fields mentioned above, but since the conductive layer is directly formed on the polarizing plate, the optical laminate does not include a separate substrate for forming the conductive layer, and thus the thickness thereof is small and the optical laminate is favorable in terms of flexural properties, so that the optical laminate may be particularly suitable for use for a smart window for a vehicle or a building. In one or more embodiments, a smart window having applied thereto the optical laminate of the present disclosure may be used as a front window, a rear window, a side window, and a sunroof window of an automobile, or a window for a building, and in addition to being used to block external light, may also be used for partitioning the internal space of an automobile or a building, or for protecting privacy, such as being used as an internal partition.

Hereinafter, embodiments of the present disclosure will be described in more detail with reference to the accompanying drawings. However, the following drawings attached to the present specification illustrate preferred embodiments of the present disclosure, and serve to aid in further understanding of the technical idea of the present disclosure together with the contents of the present disclosure described above. Therefore, the present disclosure should not be interpreted as being limited only to matters described in the drawings.

Terms used in the present specification are for purpose of describing embodiments and are not intended to limit the present disclosure. In the present specification, singular forms also include plural forms unless the context clearly indicates otherwise. For example, the term “polarizing plate” as used herein may mean at least one polarizing plate among a first polarizing plate and a second polarizing plate, and the term “transparent conductive layer” may mean at least one transparent conductive layer among a first transparent conductive layer and a second transparent conductive layer.

As used herein, terms such as “comprise”, “comprising”, “include”, and “including” are intended to denote the existence of one or more stated components, steps, operations, and/or elements, but do not exclude the existence or addition of one or more other components, steps, operations, and/or elements. Throughout the specification, like reference numerals refer to like components.

Spatially relative terms, such as “below”, “lower surface”, “beneath”, “above”, “upper surface”, “on” and the like, may be used to easily describe the relationship between one element or component(s) and other element or components(s) as illustrated in the figures. Spatially relative terms should be understood to encompass different orientations of the element in use or operation, in addition to the orientation depicted in the figures. For example, when elements illustrated in the figures are turned over, an element described as being “below” or “beneath” another element may be placed “above” the other element. Thus, the exemplary term “below” may include both the terms “above” and “below”. The element may also be oriented in a different direction, and thus spatially relative terms may be interpreted according to the orientation.

As used herein, the term “plane direction” may be interpreted as a direction orthogonal to the polarizing plate and/or the transparent conductive layer, that is, the direction of the user's view.

### <Polarizing Plate>

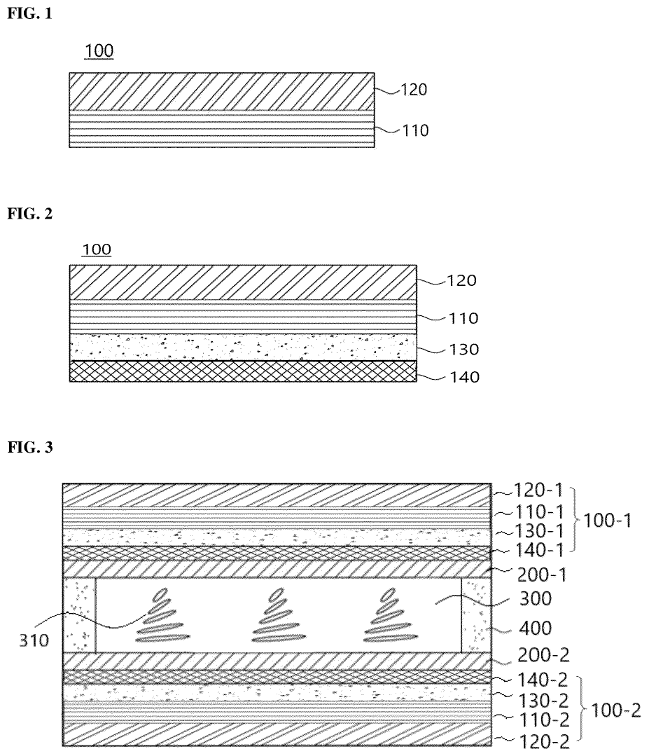

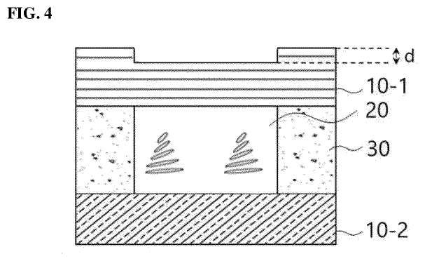

FIG. 1 shows a laminated structure of a polarizing plate according to one embodiment of the present disclosure, and FIG. 2 shows a laminated structure of a polarizing plate according to another embodiment of the present disclosure.

Referring to FIG. 1, a polarizing plate 100 according to one embodiment of the present disclosure may include a polarizer 110 and a protective film 120 formed on one surface of the polarizer.

The polarizing plate 100 may have a thickness of 150 μm to 500 μm, preferably 170 μm to 500 μm, more preferably 190 μm to 450 μm. In this case, it is possible to prevent bubble generation or lifting from occurring due to the level difference between a liquid crystal layer 300 and a sealant 400 during the glass bonding process while maintaining the optical characteristics of the polarizing plate 100.

The polarizer 110 may be a conventional or later-developed polarizer, and may be, for example, a stretched polarizer or a coated polarizer.

In one embodiment, the stretched polarizer may include a stretched polyvinyl alcohol (PVA)-based resin. The polyvinyl alcohol (PVA)-based resin may be a polyvinyl alcohol-based resin obtained by saponifying a polyvinyl acetate-based resin. Examples of the polyvinyl acetate-based resin include polyvinyl acetate, which is a homopolymer of vinyl acetate, as well as copolymers of vinyl acetate and other monomers copolymerizable therewith. Examples of the other monomers include unsaturated carboxylic acid-based monomers, unsaturated sulfonic acid-based monomers, olefin-based monomers, vinyl ether-based monomers, acrylamide-based monomers having an ammonium group, and the like. In addition, the polyvinyl alcohol (PVA)-based resin may include a modified resin, for example, aldehyde-modified polyvinyl formal or polyvinyl acetal.

In one embodiment, the coated polarizer may be formed by a liquid crystal coating composition, wherein the liquid crystal coating composition may include a reactive liquid crystal compound, a dichroic dye, and the like.

The term “reactive liquid crystal compound” may refer to a compound including, for example, a mesogen skeleton and also including one or more polymerizable functional groups. Such reactive liquid crystal compounds are variously known under the name reactive mesogen (RM). The reactive liquid crystal compound may be polymerized by light or heat to form a cured film in which a polymer network is formed while maintaining the liquid crystal alignment.

The reactive liquid crystal compound may be a monofunctional or multifunctional reactive liquid crystal compound. The monofunctional reactive liquid crystal compound may refer to a compound having one polymerizable functional group, and the multifunctional reactive liquid crystal compound may refer to a compound having two or more polymerizable functional groups.

The dichroic dye is a component included in the liquid crystal coating composition to impart polarization properties, and has different absorbances in the major and minor axis directions of the molecule. The dichroic dyes may be a conventional or later-developed dichroic dye, and may include at least one selected from the group consisting of azo dyes, anthraquinone dyes, perylene dyes, merocyanine dyes, azomethine dyes, phthaloperylene dyes, indigo dyes, dioxazine dyes, polythiophene dyes, and phenoxazine dyes.

The liquid crystal coating composition may further include a solvent capable of dissolving the reactive liquid crystal compound and the dichroic dye, and examples of the solvent include propylene glycol monomethyl ether acetate (PGMEA), methyl ethyl ketone (MEK), xylene, and chloroform. In addition, the liquid crystal coating composition may further include a leveling agent, a polymerization initiator, and the like, within a range that does not impair the polarization characteristics of the coating film.

The protective film 120 serves to prevent surface waviness while protecting the polarization characteristics of the polarizer 110 from post-processing and external environments, and may have a thickness of 100 μm to 300 μm, preferably 125 μm to 300 μm. This is more preferable in terms of reducing the level difference between the liquid crystal layer and the sealant when the protective film 120 is applied to an optical laminate.

If the protective film 120 satisfies the above thickness range, when it is applied to an optical laminate, it may prevent spots from being visible due to the level difference between the liquid crystal layer and the sealant that occurs during the glass bonding process, and improve moisture permeability and heat and moisture resistance, thereby maintaining optical characteristics.

In addition, the protective film 120 may have an in-plane retardation (Re) of less than 4,000 nm for light having a wavelength of 550 nm, as calculated by Equation 1 below.

$$Re = ( nx - ny ) \times d \qquad [ Equation 1 ]$$

In Equation 1 above, nx and ny are the x-axis and y-axis direction refractive indices of the protective film for light having a wavelength of 550 nm, respectively, and d is the thickness of the protective film.

If the protective film 120 satisfies the in-plane retardation (Re) range, it does not deteriorate optical characteristics even when having a thickness in the range of 100 μm to 300 μm, and may have good moisture permeability and heat and moisture resistance.

The protective film 120 is disposed on one surface of the polarizer 110, and when it is applied to an optical laminate, it forms the outermost part. Preferably, the protective film 120 is formed on a surface of the polarizer 110 on which the transparent conductive layer 200 is not laminated. Accordingly, the generation of bubbles in the step portion of the sealant during the glass bonding process may be effectively suppressed, and the problem of stability degradation caused by bubbles entering the liquid crystal layer of the optical laminate due to moisture permeation may be solved.

In particular, the protective film 120 included in the polarizing plate 100 of the present disclosure is characterized by being formed as a thick film. If this protective film as a thick film is disposed toward the liquid crystal layer in the optical laminate, there may be a problem in that color characteristics change depending on the viewing angle when the optical laminate is driven in the light-blocking mode.

The protective layer 120 may be formed on and in direct contact with one surface of the polarizer 110, without being limited thereto, and for example, may be formed on one surface of the polarizer 110 while including a pressure sensitive adhesive/adhesive layer described later therebetween.

The protective film 120 may have a single-layer structure, or may have a multi-layer structure in which a plurality of layers are sequentially laminated, and may be formed in direct contact with other functional layer(s).

In one or more embodiments, the protective layer 120 may include at least one selected from the group consisting of polyethylene terephthalate (PET), polyethylene isophthalate (PEI), polyethylene naphthalate (PEN), polybutylene terephthalate (PBT), diacetyl cellulose, triacetyl cellulose (TAC), polycarbonate (PC), polyvinyl chloride, polyethylene (PE), polypropylene (PP), polymethyl acrylate (PMA), polymethyl methacrylate (PMMA), polyethyl acrylate (PEA), polyethyl methacrylate (PEMA), and a cyclic olefin polymer (COP). Thereamong, polyethylene terephthalate (PET), polyethylene naphthalate (PEN), polyethylene (PE), polyvinyl chloride, and a cyclic olefin polymer (COP) are more preferable in terms of improving moisture permeability and heat and moisture resistance.

Meanwhile, referring to FIG. 2, the polarizing plate 100 may further include a retardation matching layer 130 and a hard coating layer 140 on a surface of the polarizer 110 on which the protective film 120 is not formed.

The retardation matching layer 130 is intended to match the optical properties of the optical laminate, may be in the form of a retardation film or the like, and may be a conventional or later-developed retardation film. For example, quarter-wave plates or half-wave plates may be used to retard the phase of light, and these may be used alone or in combination.

The retardation matching layer 130 may be formed on and in direct contact with the other side of the polarizer 110 on which the protective film 120 is not formed.

The retardation matching layer 130 may include either a stretched polymer film obtained by stretching a polymer film capable of imparting optical anisotropy in an appropriate manner, or a liquid crystal polymer film.

In one embodiment, the stretched polymer film may include a polymer layer including a polyolefin such as polyethylene (PE) or polypropylene (PP), a cyclic olefin polymer (COP) such as polynorbornene, a polyester such as polyvinyl chloride (PVC), polyacrylonitrile (PAN), polysulfone (PSU), acrylic resin, polycarbonate (PC), or polyethylene terephthalate (PET), a cellulose acetate-based polymer such as polyacrylate, polyvinyl alcohol (PVA) or triacetyl cellulose (TAC), or a copolymer of two or more monomers among the monomers forming the polymers.

The method of obtaining the stretched polymer film is not particularly limited, and for example, the stretched polymer film may be obtained by forming the polymer material into a film form, followed by stretching. The method for forming the polymer material into a film form is not particularly limited, and the polymer material may be formed into a film by a known method such as injection molding, sheet molding, blow molding, injection blow molding, inflation molding, extrusion molding, foam molding, cast molding, or the like. In addition, a secondary processing molding method such as pressure molding or vacuum molding may also be used. Thereamong, extrusion molding or cast molding is preferably used. In this case, for example, an unstretched film may be extrusion-molded using an extruder equipped with a T-die, a circular die, or the like. When a molded product is obtained by extrusion molding, a material prepared by melt-kneading various resin components, additives, etc. may be used and the molded product may be formed by melt-kneading during extrusion molding. Furthermore, after various resin components are dissolved using a common solvent, for example, a solvent such as chloroform or methylene chloride, an unstretched film may be cast-molded by cast drying and solidification.

The stretched polymer film may be provided by performing uniaxial stretching on the formed film in a mechanical direction (MD, longitudinal or lengthwise direction), and by performing uniaxial stretching in a transverse direction (TD, or widthwise direction) perpendicular to the MD. Alternatively, a biaxially stretched film may be manufactured by performing stretching by a sequential biaxial stretching method of roll stretching and tenter stretching, a simultaneous biaxial stretching method of tenter stretching, a biaxial stretching method of tubular stretching, or the like.

The liquid crystal polymer film may include a reactive liquid crystal compound in a polymerized state. The above description of the reactive liquid crystal compound of the coated polarizer may be equally applied to the reactive liquid crystal compound.

In one or more embodiments, the thickness of the retardation matching layer may be 10 μm to 100 μm in the case of the stretched polymer film, and 0.1 μm to 5 μm in the case of the liquid crystal polymer film.

The hard coating layer 140 is not particularly limited as long as it serves to protect members such as the polarizing plate and the transmittance variable layer from external physical or chemical impacts, and a hard conventional or later-developed hard coating layer may be used. Specifically, the hard coating layer 140, when applied to a crystalline polymer substrate to which adhesion is difficult to impart after coating, an engineering plastic substrate, or a polymer substrate whose surface has been changed to a hydrophilic one by hydrolysis or saponification, may increase adhesion without deterioration of mechanical properties, and when the polymer substrate is coated with the hard coating layer of the present disclosure after being subjected to plasma or corona treatment, the adhesion may be further increased.

In the present disclosure, a hard coating layer capable of improving surface hardness may be used in consideration of the fact that it can minimize cracks occurring during the process.

The thickness of the hard coating layer 140 may be 3 μm to 200 μm, specifically 5 μm to 100 μm, more specifically 7 μm to 30 μm, without being limited thereto. However, when the thickness of the hard coating layer 140 satisfies the above range, it is possible to form a hard coating layer that has excellent hardness, has a small thickness, and has almost no curling phenomenon. The thickness of the coating layer may refer to the thickness after drying.

The hard coating layer 140 may be formed by a known method such as die coating, air knife coating, reverse roll coating, spray coating, blade coating, casting, gravure coating, micro-gravure coating, or spin coating.

In addition, the hard coating layer 140 may be formed by applying a composition for forming a hard coating layer onto another member and then curing the same with light or heat. The composition for forming a hard coating layer is not particularly limited and may include, for example, a photocurable compound and a photoinitiator.

As the photocurable compound and the photoinitiator, those commonly used in the art may be used without limitation. For example, the photocurable compound may be a photopolymerizable monomer, a photopolymerizable oligomer, or the like, and examples thereof include monofunctional and/or polyfunctional (meth)acrylates. Examples of the photoinitiator include hydroxycyclohexyl phenyl ketone, trimethylbenzoyl diphenylphosphine oxide, acetophenone, oxime ester, etc., and commercially available photoinitiator products include Irgacure-184, TPO, Irgacure-907, etc.

The polarizing plate 100 of the present disclosure includes the protective film 120 as described above on one surface of the polarizer 110, and may further include a retardation matching layer 130 and a hard coating layer 140, which are sequentially laminated on the other surface of the polarizer 110. In addition, the polarizing plate 100 may further include a functional layer such as a refractive index-matching layer.

The refractive index-matching layer is provided to compensate for the refractive index difference of the optical laminate caused by the transparent conductive layer, and may serve to improve the viewing characteristics, etc. by reducing the refractive index difference. Furthermore, the refractive index-matching layer may be provided to correct the color caused by the transparent conductive layer. Meanwhile, when the transparent conductive layer has a pattern, the refractive index matching layer may compensate for the difference in transmittance between a pattern region with the pattern formed and a non-pattern region where no pattern is formed.

Specifically, the transparent conductive layer is laminated adjacent to other members having a refractive index different therefrom (for example, the polarizer, etc.), and the difference in the refractive index between the transparent conductive layer and other layer adjacent thereto may lead to the difference in light transmittance. In particular, if a pattern is formed on the transparent conductive layer, a problem may arise in that the pattern region and the non-pattern region are viewed to be distinguishable from each other. Therefore, the refractive index-matching layer is included to compensate for refractive index, thereby reducing the difference in light transmittance of the optical laminate. In particular, when a pattern is formed on the transparent conductive layer, the refractive index-matching layer prevents the pattern region and the non-pattern region from being viewed to be distinguishable from each other.

In one embodiment, the refractive index of the refractive index-matching layer may be appropriately selected depending on the material of another adjacent member, but is preferably 1.4 to 2.6, more preferably 1.4 to 2.4. In this case, it is possible to prevent light loss caused by a sharp difference in refractive index between the transparent conductive layer and other members such as the polarizer.

The refractive index-matching layer is not particularly limited as long as it can prevent the sharp difference in refractive index between the transparent conductive layer and other members such as the polarizer, and it may include a compound used in the formation of a conventional or later-developed refractive index matching layer. For example, the refractive index-matching layer may be formed from a refractive index-matching layer formation composition including a polymerizable isocyanate compound.

In one embodiment, the polarizing plate 100 may further include other functional layers to assist or enhance the characteristics of the polarizer, in addition to the above-mentioned functional layers and, for example, may further include an overcoat layer, etc. in order to further improve the mechanical durability.

The thickness of each of the refractive index-matching layer and the functional layers that may be further included may be 1 to 30 μm, more preferably 2 to 20 μm. Here, the thickness may refer to the thickness after drying. When each thickness satisfies the above range, each functional layer may perform its function without a problem while thinning is possible.

### <Optical Laminate>

FIG. 3 shows the structure of an optical laminate according to one embodiment of the present disclosure.

Referring to FIG. 3, an optical laminate according to one embodiment of the present disclosure may include a first polarizing plate 100-1, a second polarizing plate 100-2, a first transparent conductive layer 200-1, a second transparent conductive layer 200-2, a liquid crystal layer 300, and a sealant 400.

### Polarizing Plate

The polarizing plate 100 of the present disclosure may refer to a first polarizing plate 100-1 and a second polarizing plate 100-2, or any one of them, and the contents described in the above <Polarizing Plate> section may be equally applied to the type and characteristics of each layer constituting the polarizing plate.

The first polarizing plate 100-1 and the second polarizing plate 100-2 may include a first protective film 120-1 and a second protective film 120-2 on the surface of the first polarizer 110-1 and the surface of the second polarizer 110-2, respectively, and serve to prevent surface waviness while protecting the polarization characteristics of the first polarizer 110-1 and the second polarizer 110-2 from post-processing and external environments. The first protective film 120-1 and the second protective film 120-2 may have a thickness of 100 μm to 300 μm, preferably 125 μm to 300 μm. This is more preferable in terms of reducing the level difference between the liquid crystal layer and the sealant.

Meanwhile, the second protective film 120-2 may be smaller than or equal to the thickness of the first protective film 120-1 depending on the purpose of use and field of application of the glass-bonded product.

When the first protective film 120-1 and the second protective film 120-2 satisfy the above thickness range, they may prevent spots from being visible due to the level difference between the liquid crystal layer 300 and the sealant 400 of the polarizing plate 100, which occurs during the glass bonding process, and improve moisture permeability and heat and moisture resistance, thereby maintaining optical characteristics.

In addition, the first protective film 120-1 and the second protective film 120-2 may have an in-plane retardation (Re) of less than 4,000 nm for light having a wavelength of 550 nm, as calculated by Equation 1 below.

$$Re = ( nx - ny ) \times d \qquad [ Equation 1 ]$$

In Equation 1 above, nx and ny are the x-axis and y-axis direction refractive indices of the first and second protective films for light having a wavelength of 550 nm, respectively, and d is the thickness of each of the first and second protective films.

When the first protective film 120-1 and the second protective film 120-2 satisfy the in-plane retardation (Re) range, they do not deteriorate optical characteristics even when having a thickness in the range of 100 μm to 300 μm, and may have good moisture permeability and heat and moisture resistance.

The first protective film 120-1 and the second protective film 120-2 may each form the outermost part of the optical laminate. Preferably, they are formed on surfaces of the first polarizer 110-1 and the second polarizer 110-2, respectively, on which the transparent conductive layer 200-1, 200-2 is not formed. Accordingly, the generation of bubbles in the step portion of the sealant during the glass bonding process may be effectively suppressed, and the problem of bubbles entering the liquid crystal layer of the optical laminate due to moisture permeation may be solved.

In particular, when the first protective film 120-1 and the second protective film 120-2 of the present disclosure, which are formed as thick films, are disposed on the polarizers 110-1 and 110-2, respectively, so that they are toward the inside of the optical laminate, there may be a problem in that color characteristics change depending on the viewing angle when the optical laminate is driven in the light-blocking mode.

The first protective layer 120-1 and the second protective film 120-2 may be formed on and in direct contact with one surface of the polarizer 110-1 and one surface of the polarizer 110-2, respectively, without being limited thereto, and for example, may be formed on the polarizers 110-1 and 110-2, respectively, while including a pressure sensitive adhesive/adhesive layer described later therebetween.

Each of the first protective film 120-1 and the second protective film 120-2 may have a single-layer structure, or may have a multi-layer structure in which a plurality of layers are sequentially laminated, and may be formed in direct contact with other functional layer(s).

Meanwhile, referring to FIG. 3, each of the first polarizing plate 100-1 and the second polarizing plate 100-2 may further include a first retardation matching layer 130-1 or a second retardation matching layer 130-2 and a first hard coating layer 140-1 or a second hard coating layer 140-2, which are sequentially laminated on surfaces of the polarizers 110-1 and 110-2 on which the first protective film 120-1 and the second protective film 120-2 are not formed.

To the first retardation matching layer 130-1, the second retardation matching layer 130-2, the first hard coating layer 140-1 and the second hard coating layer 140-2, the contents described about the retardation matching layer 130 and the hard coating layer 140 in the above <Polarizing Plate> section may be equally applied, and the description of the functional layers that may further be included may also be applied equally.

### Transparent Conductive Layer

The transparent conductive layer 200-1, 200-2 is provided for driving the liquid crystal layer 300 and may be formed in direct contact with the polarizing plate 100-1, 100-2.

For example, as shown in FIG. 3, the first transparent conductive layer 200-1 may be formed in direct contact with the first polarizing plate 100-1, and the second transparent conductive layer 200-2 may be formed in direct contact with the second polarizing plate 100-2.

Conventionally, an optical laminate used to manufacture a smart window, etc. is manufactured by forming a conductive layer for driving liquid crystals on one surface of a substrate and bonding the other surface of the substrate to a polarizing plate. However, the optical laminate according to the present disclosure is characterized in that, since the conductive layer is directly formed on one surface of the polarizing plate without including a separate substrate for forming the conductive layer, the laminate has improved transmittance in a light transmission mode and improved flexural properties while having a reduced thickness.

At this time, the polarizing plate 100-1, 100-2 included in the optical laminate of the present disclosure includes a protective film having a thickness of 100 μm or more, and thus has a characteristic in that, when it is applied especially to the optical laminate, sagging and surface waviness of the film are less. Accordingly, it is easy to maintain the film's tension between rolls, and thus it is possible to produce a transparent conductive layer with less in-plane thickness variation in roll-to-roll continuous production, which is advantageous for achieving fast in-plane switching and response speed when driving a smart window.

In one embodiment, the first transparent conductive layer 200-1 and/or the second transparent conductive layer 200-2 formed in direct contact with at least one of the first polarizing plate 100-1 and the second polarizing plate 100-2 shares a contact surface with the first polarizing plate 100-1 and/or the second polarizing plate 100-2, meaning that at least one of the transparent conductive layers is formed on the polarizing plate without including a separate substrate. For example, the first transparent conductive layer 200-1 and/or the second transparent conductive layer 200-2 may be deposited and formed on the upper surface of a coating layer formed on the first polarizing plate 100-1 and/or the second polarizing plate 100-2. In this case, the first transparent conductive layer 200-1 and/or the second transparent conductive layer 200-2 may be formed in direct contact with a pretreated surface of the polarizing plate after performing pre-treatment such as corona treatment or plasma treatment on one surface of the polarizing plate in order to improve the adhesion thereof to at least one of the first polarizing plate 100-1 and the second polarizing plate 100-2. The pre-treatment is not limited to corona treatment or plasma treatment, and may be performed using any conventional or later-developed pre-treatment process within a range that does not impair the purpose of the present disclosure.

In another embodiment of the present disclosure, the first transparent conductive layer 200-1 and/or the second transparent conductive layer 200-2, which are/is formed in direct contact with at least one of the first polarizing plate 100-1 and the second polarizing plate 100-2, may be formed in direct contact with the polarizing plate with a highly adhesive layer (not shown in the figure; formed on one surface of the polarizing plate) interposed therebetween in order to improve the adhesion between the transparent conductive layer and the polarizing plate. The highly adhesive layer may be formed using a conventional or later-developed pressure-sensitive adhesive. In one or more embodiments, the pressure-sensitive adhesive may be an acrylic pressure-sensitive adhesive, a rubber-based pressure-sensitive adhesive, a silicone-based pressure-sensitive adhesive, a urethane-based pressure-sensitive adhesive, a polyvinyl alcohol-based pressure-sensitive adhesive, a polyvinyl pyrrolidone-based pressure-sensitive adhesive, a polyacrylamide-based pressure-sensitive adhesive, a cellulose-based pressure-sensitive adhesive, a vinyl alkyl ether-based pressure-sensitive adhesive, or the like. The pressure-sensitive adhesive is not particularly limited as long as it has adhesive and viscoelastic properties. However, the pressure-sensitive adhesive may preferably be an acrylic pressure-sensitive adhesive from the viewpoint of easy availability, etc., and may include, for example, a (meth)acrylate copolymer, a crosslinking agent, and a solvent, etc. The transparent conductive layer 200-1, 200-2 may be formed on one surface of

the polarizing plate 100-1, 100-2 by a deposition and coating method commonly used in art. For example, it may be formed by an appropriate process selected from coating processes such as a spin coating process, a roller coating process, a bar coating process, a dip coating process, a gravure coating process, a curtain coating process, a die coating process, a spray coating method, a doctor coating method, a kneader coating method, etc.;

printing (application) processes such as a screen printing process, a spray printing process, an inkjet printing process, a relief printing process, an intaglio printing process, a flat printing process, etc.; and deposition processes such as a chemical vapor deposition (CVD), physical vapor deposition (PVD), and plasma-enhanced chemical vapor deposition (PECVD), etc.

In the optical laminate of the present disclosure, at least one of the first transparent conductive layer 200-1 and the second transparent conductive layer 200-2 preferably has a visible light transmittance of 50% or more, and for example, may include at least one selected from the group consisting of a transparent conductive oxide, a metal, a carbonaceous material, a conductive polymer, a conductive ink, and nanowires, without being limited thereto, and a conventional or later-developed transparent conductive layer material may be used.

In one or more embodiments, the transparent conductive oxide may include at least one selected from a group consisting of indium tin oxide (ITO), indium zinc oxide (IZO), indium zinc tin oxide (IZTO), aluminum zinc oxide (AZO), gallium zinc oxide (GZO), fluorine tin oxide (FTO), zinc oxide (ZnO), and the like.

Furthermore, the metal may include at least one selected from a group consisting of gold (Au), silver (Ag), copper (Cu), aluminum (Al), platinum (Pt), palladium (Pd), chromium (Cr), titanium (Ti), tungsten (W), niobium (Nb), tantalum (Ta), vanadium (V), iron (Fe), manganese (Mn), cobalt (Co), nickel (Ni), zinc (Zn), and alloys containing at least one of these metals, and may include, for example, a silver-palladium-copper (APC) alloy or a copper-calcium (CuCa) alloy.

The carbonaceous material may include at least one selected from the group consisting of carbon nanotubes (CNTs), graphene, and the like.

The conductive polymer may be a conventional or later-developed conductive polymer material. For example, the conductive polymer may include at least one selected from the group consisting of polythiophene, poly (3,4-ethylenedioxythiophene), polyaniline, polyacetylene, polydiacetylene, polyphenylene, polyphenylene vinylene, polyphenylene sulfide, polythienylene vinylene, polythiophene vinylene, polyfluorene, polypyrrole, poly (3,4-ethylenedioxythiophene): polystyrene sulfonate, poly (3,4-ethylenedioxythiophene): camphor sulfonic acid, poly (3,4-ethylenedioxythiophene): toluene sulfonic acid, poly (3,4-ethylenedioxythiophene): dodecylbenzene sulfonic acid, polyaniline: polystyrene sulfonate, polyaniline: camphorsulfonic acid, polypyrrole: polystyrene sulfonate, polypyrrole: camphorsulfonic acid, polypyrrole: toluenesulfonic acid, polypyrrole: dodecylbenzene sulfonic acid, polythiophene: polystyrene sulfonate, polythiophene: camphorsulfonic acid, polythiophene: toluenesulfonic acid, and polythiophene: dodecylbenzene sulfonic acid, and is preferably poly (3,4-ethylenedioxythiophene).

The conductive ink may be an ink composed of a mixture of metal powder and a curable polymeric binder, and the nanowires may be, for example, silver nanowires (AgNWs).

Furthermore, at least one of the first transparent conductive layer 200-1 and the second transparent conductive layer 200-2 may be formed to have a structure consisting of two or more layers by combining the above-described materials. For example, in order to reduce the reflectivity of incident light and increase the transmittance, at least one of the first transparent conductive layer 200-1 and the second transparent conductive layer 200-2 may be formed to have a two-layer structure including a metal layer and a transparent conductive oxide layer.

In one embodiment, the transparent conductive layer 200-1, 200-2 may have a thickness of 1 μm or less, preferably 10 nm to 500 nm, more preferably 30 nm to 200 nm. In this case, the transparent conductive layer 200-1, 200-2 secures a predetermined transmittance, and does not experience a large change in characteristics due to external stress, and it is possible to manufacture an optical laminate with a small thickness.

The transparent conductive layer 200-1, 200-2 of the present disclosure may not have a separate alignment film by physically aligning itself, and an alignment film may be provided between the transparent conductive layer 200-1, 200-2 and the liquid crystal layer 300. The alignment film serves to align the liquid crystal compound, and is preferably photo-oriented. The alignment film may be formed by applying and curing an alignment film coating composition containing an alignable polymer, a photopolymerization initiator, and a solvent. The alignable polymer is not particularly limited, but may be a polyacrylate-based resin, a polyamic acid resin, a polyimide-based resin, a polymer containing a cinnamate group, or the like. In addition, a conventional or later-developed polymer capable of exhibiting alignment properties may be used.

### Liquid Crystal Layer

The liquid crystal layer 300 included in the optical laminate of the present disclosure may change the driving mode of the optical laminate to a light transmission mode or a light-blocking mode by adjusting the transmittance of light incident in one or more directions in response to an electric field generated by the transparent conductive layer 200.

The liquid crystal layer 300 may include a liquid crystal compound 310. For example, the liquid crystal layer 300 may be positioned within a space defined by a sealant layer 400 and a spacer (not shown), which are provided between the first transparent conductive layer 200-1 and the second transparent conductive layer 200-2 in the light control region.

The liquid crystal layer 300 may control the transmittance of light incident from an external light source in response to an electric field formed between the first transparent conductive layer 200-1 and the second transparent conductive layer 200-2.

The liquid crystal compound 310 is not particularly limited as long as it is driven in response to an electric field and is capable of controlling the light transmittance, and a conventional or later-developed liquid crystal compound may be used. For example, the contents regarding the reactive liquid crystal compound of the above-described coated polarizer may be equally applied to the liquid crystal compound.

The liquid crystal driving mode of the liquid crystal layer 300 is not particularly limited and may be a conventional or later-developed liquid crystal driving mode, and examples thereof include twisted nematic (TN) mode, super-twisted nematic (STN) mode, in-plane switching (IPS) mode, fringe-field switching (FFS) mode, electrically controlled birefringence (ECB) mode, and vertical alignment (VA) mode.

The liquid crystal layer 300 according to another embodiment of the present disclosure may include at least one spacer selected from the group consisting of a ball spacer and a column spacer, and is particularly preferably a ball spacer. The ball spacer may include one or more ball spacers, and preferably has a diameter of 1 μm to 10 μm. In addition, when viewed in a planar direction, the area occupied by the ball spacer in the liquid crystal layer (i.e., the light control region) is preferably 0.01 to 10% of the area of the liquid crystal layer 300 in terms of user's visibility and improved transmittance in the light transmission mode, without being limited thereto.

### Sealant

The sealant 400 may include a curable resin as a base resin. As the base resin, a UV-curable resin or thermosetting resin known in the art that may be used for a sealant may be used. The UV-curable resin may be a polymer of a UV-curable monomer. The thermosetting resin may be a polymer of a thermosetting monomer.

As the base resin of the sealant 400, for example, an acrylate-based resin, an epoxy-based resin, a urethane-based resin, a phenol-based resin, or a mixture of these resins may be used. In one embodiment, the base resin may be an acrylate-based resin, wherein the acrylate-based resin may be a polymer of an acrylic monomer. The acrylic monomer may be, for example, a multifunctional acrylate. In another embodiment, the sealant 400 may further include a monomer component in addition to the base resin. The monomer component may be, for example, a monofunctional acrylate. As used herein, the term “monofunctional acrylate” may mean a compound having one acrylic group, and the term “multifunctional acrylate” may mean a compound having two or more acrylic groups. The curable resin may be cured by UV irradiation and/or heating. The UV irradiation or heating may be appropriately performed under conditions that do not impair the purpose of the present application. If necessary, the sealant 400 may further include an initiator, for example, a photoinitiator or a thermal initiator.

The sealant 400 may be formed by a method commonly used in the art, and for example, may be formed by drawing a sealant into the outer peripheral region (i.e., inactive region) of the liquid crystal layer using a dispenser having a nozzle.

The optical laminate of the present disclosure may further include other members within a range that does not impair the purpose of the present disclosure. For example, it may further include a pressure-sensitive adhesive/adhesive layer, a UV-absorbing layer, or the like.

The pressure-sensitive adhesive/adhesive layer may be formed using an adhesive or a pressure-sensitive adhesive, and preferably has an appropriate pressure-sensitive adhesive force so that peeling, bubbles, etc. do not occur during handling of the optical laminate, as well as transparency and thermal stability.

The adhesive may be a conventional or later-developed adhesive, and for example, a photocurable adhesive may be used.

The photocurable adhesive exhibits a strong adhesive force by being crosslinked and cured with active energy rays such as ultraviolet (UV) rays and electron beam (EB), and may be composed of a reactive oligomer, a reactive monomer, a photopolymerization initiator, etc.

The reactive oligomer is an important component that determines the properties of the adhesive, and forms a cured coating film by forming a polymer bond through a photopolymerization reaction. Usable reactive oligomers include polyester-based resins, polyether-based resins, polyurethane-based resins, epoxy-based resins, polyacrylic resins, and silicone-based resins.

The reactive monomer acts as a crosslinking agent and a diluent for the above-described reactive oligomer and affects the adhesive properties. Usable reactive monomers include monofunctional monomers, polyfunctional monomers, epoxy-based monomers, vinyl ethers, and cyclic ethers.

The photopolymerization initiator acts to initiate photopolymerization by absorbing light energy to generate radicals or cations. An appropriate photopolymerization initiator selected depending on the photopolymerization resin may be used.

The pressure-sensitive adhesive may be a conventional or later-developed pressure-sensitive adhesive. In one or more embodiments, the pressure-sensitive adhesive may be an acrylic pressure-sensitive adhesive, a rubber-based pressure-sensitive adhesive, a silicone-based pressure-sensitive adhesive, a urethane-based pressure-sensitive adhesive, a polyvinyl alcohol-based pressure-sensitive adhesive, a polyvinyl pyrrolidone-based pressure-sensitive adhesive, a polyacrylamide-based pressure-sensitive adhesive, a cellulose-based pressure-sensitive adhesive, a vinyl alkyl ether-based pressure-sensitive adhesive, or the like. The pressure-sensitive adhesive is not particularly limited as long as it has adhesive and viscoelastic properties. However, the pressure-sensitive adhesive may preferably be an acrylic pressure-sensitive adhesive from the viewpoint of ease availability, etc., and may include, for example, a (meth)acrylate copolymer, a crosslinking agent, a solvent, and the like.

The crosslinking agent may be a conventional or later-developed crosslinking agent, and may include, for example, a polyisocyanate compound, an epoxy resin, a melamine resin, a urea resin, a dialdehyde, a methylol polymer, etc. Preferably, it may include a polyisocyanate compound.

The solvent may include a solvent commonly used in the field of resin compositions, and examples thereof include alcoholic compounds such as methanol, ethanol, isopropanol, butanol, and propylene glycol methoxy alcohol; ketone-based compounds such as methyl ethyl ketone, methyl butyl ketone, methyl isobutyl ketone, diethyl ketone, and dipropyl ketone; acetate-based compounds such as methyl acetate, ethyl acetate, butyl acetate, and propylene glycol methoxy acetate; cellosolve-based compounds such as methyl cellosolve, ethyl cellosolve, and propyl cellosolve; and hydrocarbon-based compounds such as hexane, heptane, benzene, toluene, and xylene. These solvents may be used alone or in combination of two or more.

The thickness of the pressure-sensitive adhesive layer may be appropriately determined depending on the type of resin acting as a pressure-sensitive adhesive, the pressure-sensitive adhesive strength, the environment in which the pressure-sensitive adhesive is used, etc. In one embodiment, the pressure-sensitive adhesive layer may have a thickness of 0.01 to 50 μm, preferably 0.05 to 20 μm, more preferably 0.1 to 10 μm, in order to ensure sufficient pressure-sensitive adhesive strength and minimize the thickness of the optical laminate.

The UV-absorbing layer is not particularly limited as long as it prevents UV-induced deterioration of the optical laminate. Examples of the UV absorber forming the UV-absorbing layer include salicylic acid-based UV absorbers (phenyl salicylate, p-tert-butyl salicylate, etc.), benzophenone-based UV absorbers (2,4-dihydroxybenzophenone, 2,2′-dihydroxy-4,4′-dimethoxybenzophenone, etc.), benzotriazole-based UV absorbers (2-(2′-hydroxy-5′-methylphenyl)benzotriazole, 2-(2′-hydroxy-3′,5′-di-tert-butylphenyl)benzotriazole, 2-(2′-hydroxy-3′-tert-butyl-5′-methylphenyl)benzotriazole, 2-(2′-hydroxy-3′,5′-di-tert-butylphenyl)-5-chlorobenzotriazole, 2-(2′-hydroxy-3′-(3″,4″,5″,6″-tetrahydrophthalimidemethyl)-5′-methylphenyl)benzotriazole, 2,2-methylenebis(4-(1,1,3,3-tetramethylbutyl)-6-(2H-benzotriazol-2-yl) phenol), 2-(2′-hydroxy-3′-tert-butyl-5′-methylphenyl)-5-chlorobenzotriazole, 2-(2′-hydroxy-3′-tert-butyl-5′-(2-octyloxycarbonylethyl)-phenyl)-5-chlorobenzotriazole, 2-(2′-hydroxy-3′-(1-methyl-1-phenylethyl)-5′-(1,1,3,3-tetramethylbutyl)-phenyl)benzotriazole, 2-(2H-benzotriazol-2-yl)-6-(linear and branched-chain dodecyl)-4-methylphenol, a mixture of octyl-3-[3-tert-butyl-4-hydroxy-5-(chloro-2H-benzotriazol-2-yl)phenyl] propionate and 2-ethylhexyl-3-[3-tert-butyl-4-hydroxy-5-(5-chloro-2H-benzotriazol-2-yl)phenyl] propionate, etc.), cyanoacrylate-based ultraviolet absorbers (2′-ethylhexyl-2-cyano-3,3-diphenyl acrylate, ethyl-2-cyano-3-(3′,4′-methylenedioxyphenyl)-acrylate, etc.), triazine-based UV absorbers, and the like. Thereamong, a benzotriazole-based UV absorber or a triazine-based UV absorber, which has high transparency and an excellent effect of preventing deterioration of the polarizing plate or the transmittance variable layer, is preferable, and a benzotriazole-based UV absorber having a more appropriate spectral absorption spectrum is particularly preferable. The benzotriazole-based UV absorber may be a bis(benzotriazole) compound, for example, 6,6′-methylenebis(2-(2H-benzo[d] [1,2,3]triazol-2-yl)-4-(2,4,4-trimethylpentan-2-yl) phenol), 6,6′-methylenebis(2-(2H-benzo[d] [1,2,3]triazol-2-yl)-4-(2-hydroxyethyl) phenol), or the like.

The polarizing plate of the present disclosure and the optical laminate including the same may further include a separate protective film attached onto the protective film 120, 120-1, 120-2 positioned at the outermost portion for product protection.

### <Smart Window, Automobile and Window for Building>

The present disclosure includes, in addition to the optical laminate including the polarizing plate of the present disclosure, a smart window including the same. As the optical laminate of the present disclosure is applied to the smart window, it is easy to handle during the process, which may prevent damage and defects

In addition, the present disclosure includes an automobile in which the smart window is applied to at least one of a front window, a rear window, a side window, a sunroof window, and an interior partition, and a window for a building including the smart window.

Hereinafter, embodiments of the present disclosure will be described in detail. However, the present disclosure may be embodied in various different forms and should not be construed as being limited to the examples disclosed below. Rather, these examples are provided so that this disclosure will be thorough and complete and will fully convey the concept of the present disclosure to those skilled in the art, and the present disclosure will only be defined by the scope of the appended claims

### Examples 1-1 to 1-4: Production of Polarizing Plates

### (1) Swelling Treatment Process

A 60-μm-thick polyvinyl alcohol film (raw film) (manufactured by Kuraray Co., Ltd., trade name: Kuraray Poval Film VF-PE #6000, average degree of polymerization: 2,400, degree of saponification: 99.9 mol %) was continuously unwound from a film roll, conveyed, and dipped in a swelling bath containing pure water at 20° C. for 30 seconds. In this swelling treatment process, roll-to-roll stretching (longitudinal uniaxial stretching) was performed by creating a difference in peripheral speed between the nip rolls. The stretching ratio with respect to the raw film was set to 2.5 times.

### (2) Dyeing Treatment Process

Next, the film that passed through the nip rolls was dipped in a dyeing bath containing pure water/potassium iodide/iodine/boric acid at a mass ratio of 100/2/0.01/0.3 at 30° C. for 120 seconds. In this dyeing treatment process, roll-to-roll stretching (longitudinal uniaxial stretching) was performed by creating a difference in peripheral speed between the nip rolls. The stretching ratio with respect to the film after the swelling treatment process was set to 1.1 times.

### (3) Crosslinking Treatment Process

Next, the film that passed through the nip rolls was dipped in a first crosslinking bath containing pure water/potassium iodide/boric acid at a mass ratio of 100/12/4 at 56° C. for 70 seconds. Roll-to-roll stretching (longitudinal uniaxial stretching) was performed by creating a difference in peripheral speed between the nip rolls and the nip rolls provided between the first crosslinking bath and the second crosslinking bath. The stretching ratio with respect to the film after the dyeing treatment process was set to 1.9 times.

### (4) Color Complementing Process

Next, the film after the crosslinking treatment was dipped in a second crosslinking bath containing potassium iodide/boric acid/pure water at a mass ratio of 9/2.9/100 at 40° C. 10 seconds.

### (5) Cleaning Treatment Process

Next, the film after the second crosslinking treatment was dipped in a cleaning bath containing pure water at 14° C. for 5 seconds, and washed with a shower volume of 5 m³/h at a shower temperature of 14° C.

### (6) Drying Treatment Process

Next, the film after the cleaning treatment process was heat-dried at 80° C. for 190 seconds by passage through a drying oven, thereby producing a polarizer film. The moisture content after drying was 13.6%, and the thickness of the obtained polarizer film was about 25 μm.

### (7) Bonding Treatment Process

Next, as an adhesive, an aqueous adhesive containing 5 parts by mass of polyvinyl alcohol per 100 parts by mass of water was prepared. Thereafter, a protective film (PET, Toyobo Co., Ltd., A4360, in-plane retardation at a wavelength of 550 nm: 3,200 nm) was laminated on one surface of the polarizer film using the prepared UV adhesive, and a retardation matching layer (KC3XR) having a thickness of 38 μm was laminated on the other surface of the polarizer film.

### (8) Formation of Hard Coating Layer

A hard coating composition was prepared by mixing 16.2 g of a dendrimer compound (Miwon Specialty Chemical Co., Ltd., SP-1106), 14.4 g of inorganic nanoparticles (50 wt % of silica particles with an average particle diameter of 10 nm to 20 nm; solvent: methyl ethyl ketone (MEK)), 1.8 g of a polyfunctional (meth)acrylate containing an ethylene glycol group, 0.7 g of a photoinitiator (1-hydroxycyclohexyl phenyl ketone), and 2.9 g of methyl ethyl ketone

The prepared hard coating composition was applied by Mayer bar coating onto the retardation matching layer, dried at 80° C. for 5 minutes, and then cured with a high-pressure mercury lamp at a light dose of 500 mJ/cm² to form a hard coating layer having a thickness of 12 μm.

The obtained laminate was exposed to UV light, and the adhesive was cured, thereby producing a first polarizing plate and a second polarizing plate in the same manner.

The thickness of each of the protective films and the polarizing plates is shown in Tables 1 and 2 below.

### Comparative Example 1-1: Production of Polarizing Plates

A first polarizing plate and a second polarizing plate were produced in the same manner as in Example 1, except that a TAC film (Hyosung Corporation, 60 μm TAC, in-plane retardation at a wavelength of 550 nm: 0.5 nm) was applied as a protective film.

### Comparative Example 1-2: Production of Polarizing Plates

A first polarizing plate and a second polarizing plate were produced in the same manner as in Example 1, except that a 50-μm-thick PET film (Toyobo Co., Ltd., A4360, in-plane retardation at a wavelength of 550 nm: 3,200 nm) was applied as a protective film.

### Test Example 1: Evaluation of Properties of Polarizing Plates

### (1) Color Change

The first polarizing plates produced in Examples 1-1 to 1-4 and Comparative Examples 1-1 and 1-2 were each cut to a size of 4 cm×4 cm, and a pressure-sensitive adhesive layer was applied to the hard coating layer side, and the resulting structure was attached to glass, thereby preparing samples.

Color a* and b* were measured using a spectrophotometer (JASCO, V-7100), and the color after 24 hours of residence in an oven (JEIOTECH, TH-TG) at 40° C. temperature and 93% RH was measured using the same method. The color change (AE) was calculated according to Equation 2 below, and the results are shown in Table 1 below.

$$Δ E = {\{ {( Δ {a}^{*} )}^{2} + {( Δ {b}^{*} )}^{2} \}}^{1 / 2} \qquad [ Equation 2 ]$$

### (2) Moisture Permeability

The first polarizing plates produced in Examples 1-1 to 1-4 and Comparative Examples 1-1 and 1-2 were each cut to a size of 4 cm×4 cm, and the weight change before and after leaving under high-humidity conditions (40° C./90% RH) for 24 hours was measured using the moisture permeability evaluation method (JIS Z 0208). The moisture permeability was calculated as [weight change (g)/moisture permeable area (m²)/day], and the results are shown in Table 1 below.

### (3) Handling Property

The first polarizing plates produced in Examples 1-1 to 1-4 and Comparative Examples 1-1 and 1-2 were each cut to a size of 10 cm×5 cm so that the MD direction became the long side. Each first polarizing plate was mounted on a mandrel holder so that the hard coating layer faced inward, and a mandrel bend test was conducted using a mandrel bending tester (M TECH, MT-3440). The maximum mandrel diameter at which cracks did not occur in the first polarizing plate was measured while bending mandrels with different diameters at 180°, and the results are shown in Table 1 below.

TABLE 1

| | | | | | | Comparative | Comparative |
|---|---|---|---|---|---|---|---|
| | | Example | Example | Example | Example | Example | Example |
| | | 1-1 | 1-2 | 1-3 | 1-4 | 1-1 | 1-2 |
| Thickness | Protective film | 125 | 100 | 150 | 125 | 60 | 50 |
| (μm) | | (PET) | (PET) | (PET) | (PET) × 2 | (TAC) | (PET) |
| | Polarizing plate | 210 | 185 | 235 | 360 | 145 | 135 |
| Polarizing | Color change | 0.3 | 0.5 | 0.2 | 0.1 | 1.3 | 1.1 |
| plate | Moisture | 0.4 | 2.3 | 0.1 | 0.0 | 12.5 | 5.8 |
| | permeability | | | | | | |
| | (g/(m² · day)) | | | | | | |
| | Handling property | 4 | 4 | 5 | 7 | 4 | 4 |
| | (mandrel, Ø) | | | | | | |

### Preparation Example 1: Formation of Transparent Conductive Layers

A composition for forming a PEDOT functional conductive layer was applied onto the first and second hard coating layers of the first and second polarizing plates (produced in each of Examples 1-1 to 1-4 and Comparative Examples 1-1 and 1-2) and dried at 90° C. for about 5 to 10 minutes to form functional conductive layers, which were then physically aligned, thereby forming a first transparent conductive layer and a second transparent conductive layer.

Here, as the composition for forming a PEDOT functional conductive layer, a mixture of 0.6 wt % of PEDOT: PSS, 32.4 wt % of ethanol, 40 wt % of deionized water, and 27 wt % of 2-methoxyethanol was used.

### Preparation Example 2: Ball Spacer Spray

A ball spacer-containing solvent was prepared by mixing 0.03 g of a ball spacer (SP series, SEKISUI Co., Ltd.) with 100 ml of isopropyl alcohol (IPA). Thereafter, the laminate manufactured through each of Examples 1-1 to 1-4 and Comparative Examples 1-1 and 1-2 and through Preparation Example 1 was placed in a spacer sprayer (SDSS-KHU02, Shindo Eng Lab), and the prepared solvent was sprayed at 110° C. and then dried for 20 minutes, thereby forming a ball spacer on the first transparent conductive layer.

### Examples 2-1 to 2-4 and Comparative Examples 2-1 and 2-2: Manufacturing of Optical Laminates

A sealant (UVF-006, 70,000 mPa·s, SEKISUI Co., Ltd.) was formed by drawing on the outer peripheral portion of the first transparent conductive layer in the laminate, manufactured through each of Examples 1-1 to 1-4 and Comparative Examples 1-1 and 1-2 and through Preparation Examples 1 and 2, using a sealant dispenser (SHOTmini 200Ωx, MUSASHI Co., Ltd.) with a sharp needle (SPN-0.25-12.7L) at a discharge pressure of 200 mPa.

A liquid crystal layer was formed by injecting liquid crystals (HPC21600, HCCH Co., Ltd.) inside the sealant on the first transparent conductive layer using the ODF (One Drop Filling) process.

In a state in which the polarizing axes of the first and second polarizing plates were arranged at 0° or 90° with each other in parallel, the polarizing plates were bonded to each other at a pressure of 3 kg/cm² so that the second polarizing plate and the second transparent conductive layer were opposite to the first polarizing plate and the first transparent conductive layer with the sealant and the liquid crystal layer interposed therebetween, thereby manufacturing optical laminates having the laminated structure shown in FIG. 3. Next, a conductive copper tape (TERAOKA, No. 8323) was attached and connected to the first transparent conductive layer and the second transparent conductive layer.

### Test Example 2: Evaluation of Properties of Optical Laminates

### (1) Measurement of Level Difference

The optical laminate sample manufactured through each of Examples 2-1 to 2-4 and Comparative Examples 2-1 and 2-2 was fixed onto soda lime glass so that the first protective film of the first polarizing plate faced upward. The level difference in the sealant region and the liquid crystal region confirmed on the surface of the first protective film of the fixed sample was measured using an interference microscope (VK-X3000, KEYENCE). The measurement magnification was 10x, and the measurement mode was VSI mode (vertical scanning interferometer). The scan range was 50 μm in the thickness direction of the sample, and the value with the largest height difference was measured as the level difference between the non-display region and the display region, and the results are shown in Table 2 below.

### (2) Reliability Evaluation

### 1) Appearance Evaluation

For the optical laminate manufactured through each of Examples 2-1 to 2-4 and Comparative Examples 2-1 and 2-2, samples were prepared by fixing both sides to glass. After 1,000 hours under high-humidity conditions (60° C./90% RH), the appearance was visually observed to check the number of defects such as spots and bubbles, and the size of each defect was checked using an OLYMPUS optical microscope MX61, and the size of the largest defect among the sizes was recorded. Evaluation was performed according to the defect evaluation criteria below, and the results are shown in Table 2 below.

### <Criteria for Evaluating Appearance Defects>

⊚: a number of defects of 2 or less/a defect size of 0.1 mm or less
∘: a number of defects of more than 2 to not more than 5/a defect size of more than 0.1 mm to not more than 0.3 mm
Δ: a number of defects of more than 5 to not more than 10/a defect size of more than 0.3 mm to not more than 0.7 mm
x: Δ: a number of defects of more than 10/a defect size of more than 0.7 mm

### 2) Evaluation of Optical Performance

For the optical laminate manufactured through each of Examples 2-1 to 2-4 and Comparative Examples 2-1 and 2-2, samples were prepared by fixing both sides to glass. After 1,000 hours under high-humidity conditions (60° C./90% RH), the transmittance change rate was measured using a spectrophotometer (CM-3700d, Konica Minolta), and the optical performance was evaluated according to the evaluation criteria below. The results are shown in Table 2 below.

### <Criteria for Evaluating Optical Performance>

⊚: a transmittance change rate of 1% or less
∘: a transmittance change rate of more than 1% to not more than 2%
Δ: a transmittance change rate of more than 2% to not more than 3%
x: a transmittance change rate of more than 3% to not more than 4%

TABLE 2

| | | | | | | | Comp. | Comp. |
|---|---|---|---|---|---|---|---|---|
| | | | Example | Example | Example | Example | Example | Example |
| | | | 2-1 | 2-2 | 2-3 | 2-4 | 2-1 | 2-2 |
| Thickness | First protective film | | 125 | 100 | 150 | 125 | 60 | 50 |
| (μm) | | | (PET) | (PET) | (PET) | (PET) × 2 | (TAC) | (PET) |
| | Second protective film | | 125 | 100 | 150 | 125 | 60 | 50 |
| | | | (PET) | (PET) | (PET) | (PET) × 2 | (TAC) | (PET) |
| | First polarizing plate/ | | 210/ | 185/ | 235/ | 360/ | 145/ | 135/ |
| | Second polarizing plate | | 210 | 185 | 235 | 360 | 145 | 135 |
| Optical | Sealant boundary level | | 1.5 | 2.7 | 0.8 | 0.1 | 4.4 | 4.2 |
| laminate | difference (μm) on surface | | | | | | | |
| | Reliability | Appearance | ⊚ | ◯ | ⊚ | ⊚ | X | X |
| | evaluation | Optical | ⊚ | ◯ | ⊚ | ⊚ | X | X |
| | | performance | | | | | | |

From the property evaluation results shown in Table 1 and Table 2 above, it can 5 be confirmed that, when the thickness of the protective film positioned at the outermost portion of the polarizing plate of the present disclosure satisfies the range of 100 μm to 300 μm, the color change and moisture permeability under high-temperature and high-humidity conditions are low, so that heat and moisture resistance are excellent while handling properties are good. In addition, it can be confirmed that, in the optical laminate including the protective film, the occurrence of the level difference between the liquid crystal layer and the sealant is minimized, defects such as spots and bubbles due to the occurrence of the level difference do not occur, and the optical characteristics under high-humidity conditions are maintained even when the thick protective film is applied, suggesting that the optical laminate has excellent reliability.

In contrast, it can be confirmed that, in the Comparative Examples in which the thickness of the protective film positioned at the outermost portion of the polarizing plate does not satisfy the above range, the color change and moisture permeability under high-temperature and high-humidity conditions are not good compared to those in the Examples, and the level difference between the liquid crystal layer and the sealant in the optical laminate including the protective film is much larger than that in the Examples, and for this reason, defects occur and visibility is reduced.

What is claimed is:

1. A polarizing plate for an optical laminate, comprising: a polarizer; and a protective film formed on one surface of the polarizer,
wherein the protective film has a thickness of 100 μm to 300 μm.

2. The polarizing plate of claim 1, wherein the polarizing plate has a thickness of 150 μm to 500 μm.

3. The polarizing plate of claim 1, wherein the protective film has an in-plane retardation of less than 4,000 nm for light having a wavelength of 550 nm.

4. An optical laminate comprising:
a first polarizing plate;
a first transparent conductive layer formed on one surface of the first polarizing plate;
a second polarizing plate opposite to the first polarizing plate;
a second transparent conductive layer formed on one surface of the second polarizing plate and opposite to the first transparent conductive layer;
a liquid crystal layer provided between the first transparent conductive layer and the second transparent conductive layer; and
a sealant formed along an outer peripheral surface of the liquid crystal layer,
wherein at least one of the first transparent conductive layer and the second transparent conductive layer is formed in direct contact with any one of the first polarizing plate and the second polarizing plate, and
the first polarizing plate and the second polarizing plate comprise a first protective film and a second protective film, respectively, on surfaces on which the first transparent conductive layer and the second transparent conductive layer are not formed,
wherein the first protective film and the second protective film each have a thickness of 100 μm to 300 μm.

5. The optical laminate of claim 4, wherein the first polarizing plate and the second polarizing plate each have a thickness of 150 μm to 500 μm.

6. The optical laminate of claim 4, wherein the first protective film and the second protective film have an in-plane retardation of less than 4,000 nm for light having a wavelength of 550 nm.

7. The optical laminate of claim 4, wherein at least one of the first polarizing plate and the second polarizing plate further comprises a first retardation matching layer or a second retardation matching layer on a surface on which the first protective film or the second protective film is not formed.

8. The optical laminate of claim 4, wherein at least one of the first polarizing plate and the second polarizing plate comprises, on the retardation matching layer, at least one functional layer selected from the group consisting of a hard coating layer and a refractive index-matching layer.

9. The optical laminate of claim 4, wherein at least one of the first transparent conductive layer and the second transparent conductive layer is formed in direct contact with any one of the first polarizing plate and the second polarizing plate without comprising a separate substrate therebetween.

10. The optical laminate of claim 4, wherein at least one of the first transparent conductive layer and the second transparent conductive layer is formed in direct contact with any one of the first polarizing plate and the second polarizing plate while comprising a highly adhesive layer therebetween.

11. A smart window comprising the optical laminate of claim 4.
